(19) United States
(12) Patent Application Publication
(10) Pub. No.: US 2025/0229653 A1
(43) Pub. Date: Jul. 17, 2025

(54) STATIONARY INDUCTIVE CHARGING DEVICE

(71) Applicant: MAHLE International GmbH, Stuttgart (DE)

(72) Inventors: Thomas Himmer, Reichenbach (DE); Holger Schroth, Maulbronn (DE)

(21) Appl. No.: 18/854,532

(22) PCT Filed: Mar. 1, 2023
(86) PCT No.: PCT/EP2023/055131

§ 371 Date: Oct. 5, 2024

(30) Foreign Application Priority Data
Apr. 7, 2022 (DE) 10 2022 203 478.3

(51) Int. Cl. B60L 53/122; B60L 53/302

(52) U.S. Cl. CPC B60L 53/122; B60L 53/302

(57) ABSTRACT

A stationary induction charging device may include a coil for providing an electromagnetic alternating field, a power electronics unit, a cooling plate connected to components of the power electronics unit and to the coil in a heat-transferring manner, a cooling device, and a ventilation device. The power electronics unit may be configured to supply energy to and control the coil. The cooling device may include a cooling duct system with a plurality of cooling ducts extending in the cooling plate and a delivery device for driving coolant in the cooling duct system. The ventilation device may include an air duct system with an air duct connected to the cooling plate in a heat-transferring manner, a fan configured to drive the air in the air duct system, an air inlet, and an air outlet. The air inlet and outlet may communicate with a surrounding area of the induction charging device.

### CROSS-REFERENCE TO RELATED APPLICATIONS

This application claims priority to International Patent Application No. PCT/EP2023/055131, filed on Mar. 1, 2023 and German Patent Application No. DE 10 2022 203 478.3, filed on Apr. 7, 2022, the contents of both of which are hereby incorporated by reference in their entirety.

### TECHNICAL FIELD

The present invention relates to a stationary induction charging device, which is preferably used in an inductive vehicle charging system that is used to charge the battery for a battery-electric vehicle. The invention also relates to an inductive vehicle charging system equipped with such a stationary induction charging device.

### BACKGROUND

A vehicle charging system of this kind includes a stationary induction charging device, which can also be referred to as a ground assembly and which is usually arranged in a fixed location, for example at a vehicle parking space, and is connected to an electrical power supply, and a mobile induction charging device, which can also be referred to as a vehicle assembly and which is arranged on the respective vehicle, in particular on the vehicle floor. The mobile induction charging device is in this case appropriately coupled to the battery of the vehicle, e.g., via a corresponding vehicle-side charger. To charge the battery, the vehicle is positioned with its mobile induction charging device with respect to the stationary induction charging device in such a way that electrical energy can be transferred from the stationary induction charging device to the mobile induction charging device by means of induction, i.e., via an electromagnetic alternating field. The inductive vehicle charging system does not require plugs that have to be inserted into the vehicle charging sockets.

A stationary induction charging device has a coil for generating an electromagnetic alternating field, which can also be referred to as a resonator coil, and power electronic unit for supplying energy to the coil and for controlling the coil. During operation of the stationary induction charging device, heat is generated in the components of the power electronic unit and in the coil. At high power, a comparatively large amount of heat is generated, which must be dissipated to avoid damaging the power electronic unit and the coil and to increase the service life of the power electronic unit and the coil.

### SUMMARY

The present invention is concerned with the problem of providing a design for a stationary induction charging device that is characterized by efficient heat dissipation, wherein the aim in particular is to achieve low acoustic emissions.

According to the invention, this problem is solved by the subject-matter of the independent claim(s). Advantageous embodiments are the subject-matter of the dependent claim(s).

The invention is based on the general idea of equipping the stationary induction charging device with a cooling plate, a cooling device, and a ventilation device. The cooling plate dissipates heat from the components of the power electronic unit and the coil. The cooling device dissipates heat from the cold plate and transfers it to a coolant. The ventilation device dissipates the heat from the coolant and, if present, the cooling plate and the surrounding area of the induction charging device. For this purpose, the cold plate is connected to the coil and to the components of the power electronic unit on its upper side in a heat-transferring manner. The cooling device comprises a cooling duct system with several cooling ducts running in the cooling plate and having a coolant, and a delivery system that drives the coolant in the cooling duct system. The ventilation device comprises an air duct system having at least one air duct connected to the upper side of the plate in a heat-transferring manner and conducting air, at least one fan for driving the air in the air duct system, at least one air inlet communicating with the surrounding area of the induction charging device, and at least one air outlet communicating with the surrounding area. The respective air duct, which is connected to the cooling plate in a heat-transferring manner, is of particular importance here. This allows heat to be transferred from the cold plate or coolant and into the air, which ultimately transports the heat into the surrounding area. In other words, the cold plate is used to dissipate heat in the region of the respective air duct, while it is used to absorb heat in the region of the power electronic unit and coil. Within the cold plate, this heat absorption and heat dissipation occur at different, spaced-apart points. The cooling device, with its cooling ducts laid in the cooling plate, serves to support heat transfer within the cooling plate from the heat absorption point to the heat emission point. In other words, the cooling device connects heat sources with the cooling duct system, namely the power electronic unit and the coil, to which the cooling plate is coupled in a heat-transferring manner, with at least one heat sink, which is formed by the respective air duct and to which the cooling plate is coupled in a heat-transferring manner at a distance from the heat sources. With the help of the respective air duct, a comparatively large amount of heat can be dissipated from the cold plate, resulting in efficient heat dissipation. Components of the power electronic unit that generate a relatively large amount of heat during operation can be found, for example, in an active rectifier, a so-called PFC (Power Factor Correction), and in an active inverter. Such components are, in particular, power transistors.

Efficient heat dissipation also has another advantage. The improved heat transfer to the air means that the air volume flow required for heat dissipation can be reduced. A reduced air volume flow also results in a reduction of the conveying capacity of the respective fan, so that the respective fan can be operated in particular at a reduced speed. This in turn significantly reduces the noise that can be caused by a powerful fan operating at high speed. Thus, the induction charging device according to the invention is also characterized by reduced noise emission.

According to a favorable embodiment, the stationary induction charging device can have a housing that has the cooling plate on its underside and a cover plate on its upper side. Furthermore, the power electronic unit in the housing can be covered by an electronics housing. In addition, the coil in the housing can be covered by a coil housing. The respective air duct can now be delimited at the bottom by the cooling plate or by a separate duct base plate with respect to the cooling plate, at the top by the cover plate, and laterally by a lateral wall of the electronics housing facing the coil housing and by a lateral wall of the coil housing facing the electronics housing. This results in a cost-effective realization of the respective cooling duct using components that are available anyway.

Alternatively, the respective air duct can be formed in a duct body that is a separate component from the cooling plate. The heat transfer performance of such a duct can be optimized to improve the heat transfer to the air flowing through it. For example, the duct body can be made of metal, preferably a light metal such as an aluminum alloy. Furthermore, it is conceivable to arrange heat transfer structures in the duct body, such as fins, webs, turbulators and the like, in order to improve heat transfer to the air. Furthermore, it is conceivable that several flow ducts running parallel to each other are formed in the duct body, which are separated from each other by ribs or walls. The duct body can be configured as a profile body and can be produced in particular by extrusion. This provides more surface area for heat transfer, which improves the efficiency of the heat transfer.

Regardless of the other design features of the respective air duct, another embodiment may provide that the respective air duct has a duct base plate which forms the lower boundary of the air duct, which is a separate component from the cooling plate and which is connected to the cooling plate in a heat-transferring manner. This duct base plate can in particular be a component of the aforementioned duct body. The use of such a duct base plate or duct body allows for cooling ducts in the cooling plate that are open at the top, so that the coolant can come into direct contact with the duct base plate or duct body, which facilitates heat dissipation.

One embodiment in which the respective fan, i.e., the single fan or all fans, is/are arranged in the respective air duct at a distance from the air inlet and at a distance from the air outlet, is particularly advantageous. The respective distance is at least as large as a duct width measured perpendicular to the direction of air flow. By placing the fan(s) in a central region of the air duct, away from the air inlet and outlet, the sound generated by the fan(s) occurs in this central region. The sound path to the air inlet and air outlet dampens sound emissions into the surrounding area. If several fans are arranged in series, it is also advisable to arrange them at a distance from each other in the air duct.

According to a preferred embodiment, the components of the power electronics can be arranged in an electronics region of the cooling plate, in particular on the upper side of the plate, the coil can be arranged in a coil region of the cooling plate, in particular on the upper side of the plate, and the respective air duct and the respective fan are arranged in a heat exchanger region of the cooling plate, in particular the plate upper side, which is arranged in the longitudinal direction of the induction charging device between the electronics region and the coil region. In this case, the heat sink is located between the two heat sources, which also favors efficient heat dissipation.

It may now be useful for the cooling duct system to have an electronics subsystem with at least one cooling duct running in the electronics region. The cooling duct system can then have a coil subsystem that extends in the coil region and has at least one cooling duct. Optionally, the cooling system can also have a heat exchanger subsystem that runs in the heat exchanger region and has at least one cooling duct. By dividing the cooling duct system into several subsystems, the subsystems and their cooling ducts can be optimized in terms of heat transfer performance for the respective region. In particular, the heat absorption in the electronics region and in the coil region and the heat dissipation in the heat exchanger region can be improved.

One embodiment in which the three subsystems mentioned, namely the electronics subsystem, the coil subsystem, and the heat transfer subsystem, are each connected in series by a connecting cooling duct in such a way that the coolant is first conducted through the more thermally sensitive electronics region, then through the less thermally sensitive coil region, and finally through the heat exchanger region. This design ensures that the sensitive components in the electronics region are cooled by coolants at the lowest temperature, that the less sensitive components in the coil region can still be sufficiently cooled by the coolant at a slightly higher temperature, and that the coolant is transferred at a maximum temperature in the heat exchanger region to the air flowing through the air duct.

Another embodiment proposes that heat exchanger structures are arranged in at least one cooling duct of the electronics subsystem and/or the coil subsystem and/or the heat exchanger subsystem. These heat exchanger structures improve heat transfer between the coolant and the cooling plate. The heat exchanger structures may, for example, be fins, webs, studs, lamellae, or turbulators. Such a heat exchanger structure can be arranged in a heat-absorbing cooling duct, e.g., in the region of the components of the power electronic unit that give off a relatively large amount of heat during operation, or in a heat-emitting cooling duct, e.g., in the region of the respective air duct.

Another embodiment proposes that at least one cooling duct of the heat exchanger subsystem is open in the region of the respective air duct on the upper side of the plate, so that the coolant comes into direct contact with the respective air duct when the induction charging device is in operation. In other words, in the region of the respective air duct, the respective cooling duct has an open side on the upper side of the plate that is covered by the air duct. In this case, the respective cooling duct has the aforementioned duct body and/or the aforementioned duct base plate. Thus, a floor section of the duct body or a section of the duct base plate forms a boundary of the cooling duct. This realizes direct heat transfer from the coolant to the duct body and the duct base plate.

In another embodiment, the heat exchanger subsystem can have at least one cooling duct that is connected downstream of the electronic subsystem in series. In this case, the coolant flows first through the electronic subsystem and then through the respective cooling duct of the heat transfer subsystem when the induction charging device is in operation. As a result, the heat transferred to the coolant in the electronics region can already be released again by the coolant in the heat exchanger region.

Another embodiment proposes that the heat exchanger subsystem has at least one cooling duct that is arranged between two cooling ducts of the coil subsystem and connected in series with it. This design ensures that the coolant flows alternately in the coil region for heat absorption and in the heat exchanger region for heat dissipation.

Another embodiment proposes that one cooling duct of the cooling duct system forms a coil feed line that carries the coolant from the delivery device to the coil subsystem and that another cooling duct of the cooling duct system forms an electronic feed line separate from the coil feed line that carries the coolant from the delivery device to the electronic subsystem. Furthermore, the cooling duct system can have a cooling duct that forms a common return line that combines coolant from at least two subsystems. This results in a simplified structure for the cooling duct system. The separately designed feed lines for the coil and the power electronic unit enable the cooling capacity to be individually adjusted and optimized.

Another training program suggests that the electronic feed line forms a distributor for the electronic subsystem, from which several electronic subsystem cooling ducts run in parallel and lead to an electronic subsystem collector. It is clear that a corresponding design with a distributor, collector, and cooling ducts connecting them can also be realized for the coil subsystem.

It is useful to have at least one cooling duct of the heat exchanger subsystem downstream of the collector, leading to the common return line. This means that the coolant used to cool the power electronic unit first flows through the electronics subsystem and then through the heat exchanger subsystem.

In another embodiment, the coil subsystem can have several cooling ducts that run parallel to the longitudinal direction of the induction charging device and are spaced apart from one another in the transverse direction of the induction charging device. The coil subsystem can also have several connecting ducts that run parallel to the transverse direction and connect neighboring cooling ducts in the coil region. The heat exchanger subsystem can now have at least one cooling duct that runs parallel to the transverse direction and connects neighboring cooling ducts of the coil subsystem in the heat exchanger region. In this way, one of the connecting ducts is positioned in the heat exchanger region, so that it serves as a cooling duct for heat transfer to the air.

In another advantageous embodiment, the at least one fan can be arranged in a remote region for both air inlet and air outlet, in particular in a central region of the air duct in the direction of air flow, whereby the essential acoustic emissions are also generated in this remote or central region of the air duct. The increased distance between the openings of both the air inlet and the air outlet and the surrounding area results in a higher degree of acoustic attenuation between the fans as sound generators and the openings emitting sound into the surrounding area, thereby reducing the actual acoustic load emitted into the surrounding area.

Another embodiment proposes that one air duct of the air duct system forms an inlet duct that conducts air from the respective air inlet to the respective fan, while another air duct of the air duct system forms an outlet duct that conducts air from the respective fan to the respective air outlet. The air inlet and outlet are located at opposite ends of the cooling plate, in particular at its transverse ends, which are spaced apart in the transverse direction.

In another advantageous embodiment, the ventilation device can have two fans, namely a first fan and a second fan. In principle, it is possible to operate the two fans in parallel. However, a row arrangement of the fans is preferred. The inlet duct can now lead to the first fan. Another air duct of the air duct system forms a connecting duct that carries air from the first fan to the second fan. The outlet duct can now be routed from the second fan to the respective air outlet. The use of two fans helps to equalize flow resistance or pressure drops that occur when air flows through the ducts. Flow resistance and pressure drops are especially high when the duct is equipped with ribs, webs, fins, turbulators, or other heat transfer structures.

Another advantageous embodiment proposes that the induction charging device has a frame structure that connects to the cooling plate at the edge. This frame structure can have an inlet region that extends at a first transverse end of the cooling plate in the electronics region and in the coil region, as well as optionally in the heat exchanger region, which contains several air inlet openings open to the surrounding area and an air collection duct connecting the air inlet openings to the respective air inlet. The frame structure can also have an outlet region that extends in the transverse direction from the first transverse end, away from a second transverse end of the cooling plate, in the electronics region and in the coil region, as well as optionally in the heat exchanger region, which contains several air outlet openings open to the surrounding area and an air distribution duct connecting the air outlet openings to the respective air outlets. This measure integrates the frame structure into the air flow. At the same time, the frame structure can contribute to cooling the cold plate or dissipating heat.

Further training is particularly useful in which the inlet region also extends over part of a first longitudinal end of the cooling plate in the electronics region. Additionally or alternatively, the inlet region can also extend over part of a second longitudinal end of the cooling plate in the coil region. In addition or as an alternative, the outlet region can also extend over part of a first longitudinal end of the cooling plate in the electronics region. In addition or as an alternative, the outlet region can also extend over part of a second longitudinal end of the cooling plate in the coil region. The inlet and outlet regions can be L-shaped or C-shaped in a plan view that is parallel to the vertical direction, i.e., perpendicular to the longitudinal direction and perpendicular to the transverse direction. The frame structure connects to the edge of the cold plate along the transverse and longitudinal ends. By increasing the inlet region and/or outlet region at the longitudinal ends of the cold plate, the coupling in a heat-transferring manner between the inlet region and the cold plate and between the outlet region and the cold plate can be improved because more surface area is available. Furthermore, the increased size of the inlet and outlet regions also reduces the speed of the air flowing in and out through the frame structure, which of course also reduces the noise caused by the air flow. The aim is to minimize noise emissions to the surrounding area by ensuring that the inlet and outlet regions are as diffuse as possible and cover as much of the machine as possible.

According to another advantageous embodiment, it may be provided that at least one cooling duct of the cooling duct system, preferably a feed line duct, extends in an edge region of the cooling plate that is assigned to the inlet region. In addition or as an alternative, at least one cooling duct of the cooling duct system, preferably a return line duct, can extend in an edge region of the cooling plate assigned to the outlet region.

At least one cooling fin can be arranged in at least one or in several or in all air inlet openings, which is connected to the cooling plate in a heat-transferring manner. In addition or as an alternative, at least one cooling fin can be arranged in at least one or in several or in all air outlet openings, which is connected to the cooling plate in a heat-transferring manner. This significantly improves heat transfer between the cold plate and the air at the inlet and outlet.

Another embodiment suggests that at least one air filter is arranged in the inlet region. In particular, an air filter can be arranged in at least one or in several or in all air inlet openings. This can reduce contamination of the ventilation device, in particular of the respective fans and the respective air ducts, as well as of the heat exchanger structures optionally located therein.

The cooling device can be designed as a cooling circuit, wherein the conveying device is a pump and the coolant is a cooling liquid. The cooling circuit may also include an expansion tank, which is usefully located on the upstream or suction side of the pump. Alternatively, it is also possible to design the cooling device as a refrigeration circuit, wherein the conveying device is a compressor and the coolant is a refrigerant. While a coolant remains liquid in the cooling circuit, the refrigerant in the cooling circuit alternately undergoes a phase transition from the liquid phase to the gas phase and back again from the gas phase to the liquid phase. An expansion valve is appropriately arranged in the cooling circuit. A vaporizer region of the cooling circuit, in which the refrigerant evaporates, is conveniently located in the region of the respective heat source to provide efficient cooling there. A condenser region of the cooling circuit is then expediently located in the region of the respective heat sink, in order to enable efficient heat dissipation there. Depending on the number of heat sources, there may be several evaporator regions.

An inductive vehicle charging system according to the invention, which is used to charge a battery of a battery-powered electric vehicle, is equipped with a stationary induction charging device of the type described above and with a mobile induction charging device that is arranged in or on the respective vehicle. In the operational state, the stationary induction charging device is stationary in or on the background of a vehicle parking space and is electrically connected to a power grid. The mobile induction charging device is located in or on the floor of the vehicle and is electrically connected to a battery charger located in the vehicle, which in turn is electrically connected to the battery of the vehicle.

Other important features and advantages of the invention can be seen from the dependent claims, from the drawings, and from the associated description of the figure based on the drawings.

It is understood that the above-mentioned features and those yet to be explained below can be used not only in the combination indicated in each case, but also in other combinations or on their own, without deviating from the scope of the invention. The above-mentioned components of a superordinate unit, such as a device, an apparatus, or an arrangement, which are designated separately, can form separate parts or components of this unit or be integral regions or sections of this unit, even if this is shown differently in the drawings.

Preferred exemplary embodiments of the invention are shown in the drawings by way of example and will be explained in more detail in the following description, wherein identical reference numbers refer to identical or similar or functionally identical elements.

### BRIEF DESCRIPTION OF THE DRAWINGS

It shows, in each case schematically,

FIG. 1 shows a greatly simplified horizontal section showing the principle of a stationary induction charging device in the region of a ventilation device,

FIG. 2 shows a sectional view as in FIG. 1, but for a different embodiment,

FIG. 3 shows a greatly simplified horizontal section of the stationary induction charging device in the region of a cooling device,

FIG. 4 shows a sectional view as in FIG. 3, but for a different embodiment,

FIG. 5 shows a sectional view as in FIGS. 3 and 4, but for a further embodiment,

FIG. 6 shows a highly simplified cross-section of the stationary induction charging device in an inlet region of a frame structure,

FIG. 7 shows a sectional view as in FIG. 6, but in an outlet region of the frame structure in another embodiment,

FIG. 8 shows a simplified view of the stationary induction charging device in the region of the openings on the edge, as viewed in direction VIII in FIGS. 6 and 7,

FIG. 9 shows a greatly simplified longitudinal section of the stationary induction charging device in the region of the frame structure from FIG. 7.

### DETAILED DESCRIPTION

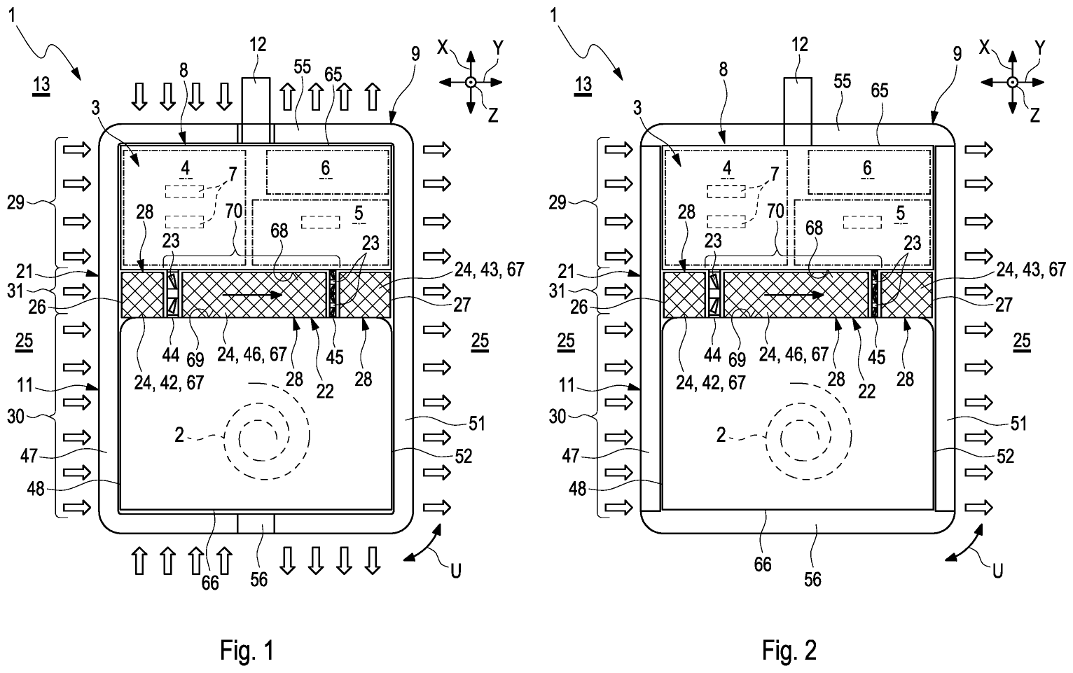

According to FIGS. 1 through 5, a stationary induction charging device 1 comprises at least one coil 2, as indicated in FIGS. 1 and 2, for generating an electromagnetic alternating field. In FIGS. 1 and 2, the coil 2 is indicated with a dashed line. The coil 2 can be a single coil or a coil arrangement consisting of several coils.

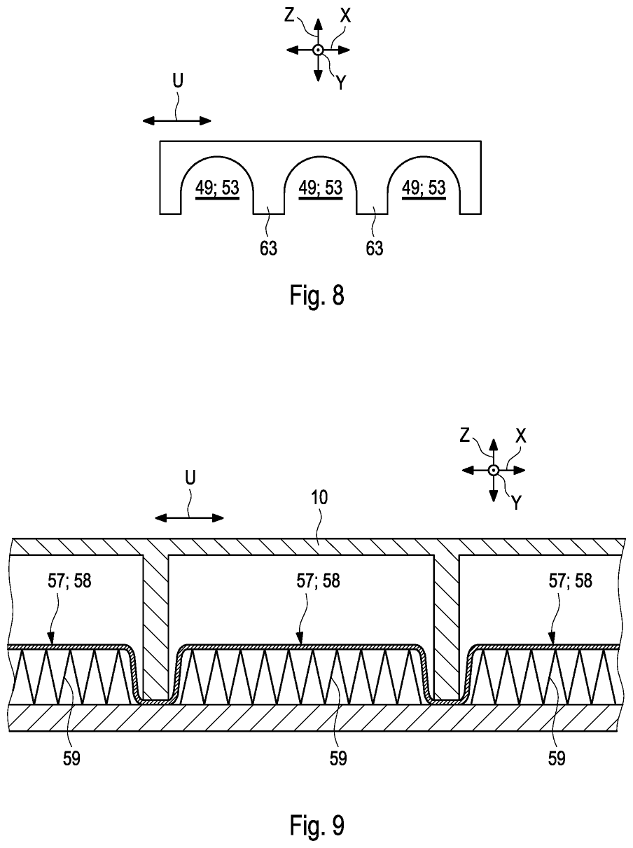

The induction charging device 1 has a longitudinal direction X, a transverse direction Y perpendicular to the longitudinal direction X, and a vertical direction Z perpendicular to the longitudinal direction X and perpendicular to the transverse direction Y. When the stationary induction charging device 1 is properly positioned and ready for operation, the vertical direction Z extends parallel to the direction of gravity. The longitudinal direction X, the transverse direction Y, and the vertical direction Z of the induction charging device 1 are indicated by double arrows in FIGS. 1 through 9, wherein the sectional planes of FIGS. 1 through 5 run perpendicular to the vertical direction Z, so that only the longitudinal direction X and the transverse direction Y can be seen there. In contrast, in FIGS. 6 and 7 the sectional plane runs perpendicular to the longitudinal direction X, so that only the transverse direction Y and the vertical direction Z are recognizable there. In FIGS. 8 and 9, the section plane is perpendicular to the longitudinal direction X, so that only the longitudinal direction X and the vertical direction Z are visible.

The induction charging device 1 also has a power electronics unit 3, as indicated in FIGS. 1 and 2, for supplying energy to the coil 2 and for controlling the coil 2. FIGS. 1 and 2 show three possible examples of power electronic units 3, namely an active rectifier 4, an active inverter 5, and a control unit 6. The power electronic unit 3 has components 7 that are assigned to these units. As examples, three such components 7 are indicated by a dashed line in FIGS. 1 and 2. These are components 7, such as power transistors, which generate a particularly large amount of heat during operation of the power electronic unit 3.

Furthermore, the induction charging device 1 is equipped with a cooling plate 8, which is shown in different embodiments in FIGS. 1 through 5 and serves to dissipate heat from the coil 2 and from the power electronic unit 3. For this purpose, the cooling plate 8 is connected to the components 7 of the power electronic unit 3 and to the coil 2 in a heat-transferring manner at its upper side, which faces the observer in FIGS. 1 through 5. The cooling plate 8 forms a base plate of the induction charging device 1 or an underside of the induction charging device 1. Accordingly, when used properly, the induction charging device 1 rests with the cooling plate 8 on a stable surface.

Incidentally, the induction charging device 1 has a housing 9 that has the cooling plate 8, designed as a base plate, on its underside, a cover plate 10 on an upper side of the induction charging device 1, as indicated in FIGS. 6, 7, and 9, and is enclosed by a frame structure 11 on the sides and edges. The housing 9 is designed to be driven over or across. For this purpose, the frame structure 11 can be designed in the form of a ramp or wedge, as can be seen in FIGS. 6, 7, and 9. When ready for operation, the induction charging device 1 is connected to a power supply by means of an electrical connection 12.

The stationary induction charging device 1 usually forms an essential part of an otherwise non-represented inductive vehicle charging system 13, which also has a mobile induction charging device on the vehicle side that is not shown here.

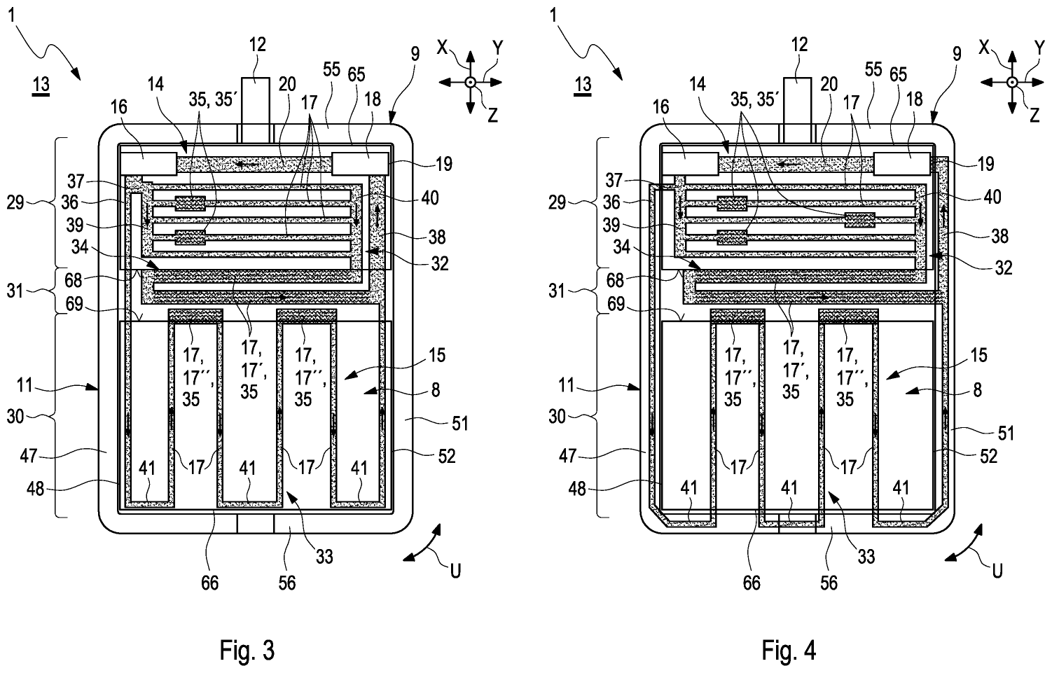

The induction charging device 1 is also equipped with a cooling device 14, as indicated in FIGS. 3 through 5, which has a cooling duct system 15 and a conveyor device 16. The cooling duct system 15 has several cooling ducts 17 running inside the cooling plate 8, which carry a coolant. The coolant is driven by the feed device 16 in the cooling duct system 15. The cooling device 14 can also have an expansion tank 18 with a sealable filling opening 19. A suction line 20 connects the equalizing tank 18 to the feed system 16. In FIGS. 3 through 5, the preferred direction of flow of the coolant in the cooling duct system 15 is indicated by arrows.

The induction charging device 1 also has a ventilation device 21, as indicated in FIGS. 1 and 2, which has an air duct system 22 and at least one fan 23. The air duct system 22 has at least one air-conducting air duct 24, which is connected to the cooling plate 8 or to its plate upper side in a heat-transferring manner. In the example of FIGS. 1 and 2, three fans 23 are provided in each case, which are arranged in series and in parallel with respect to the air flow. The air flow that occurs when the ventilation device 21 is in operation is indicated by arrows in FIGS. 1 and 2. The ventilation device 21 also has at least one air inlet 26 communicating with the surrounding area 25 of the induction charging device 1 and at least one air outlet 27 communicating with the surrounding area 25. In the example of FIGS. 1 and 2, the air duct system 22 has three air ducts 24, which will be explained in more detail below.

Furthermore, the three fans 23 shown in FIGS. 1 and 2 are arranged in a region remote from both the air inlet 26 and the air outlet 27, that is to say, in a central region 70, in the direction of air flow, of the air duct 24, which is indicated in FIGS. 1 and 2 by a curly bracket. By positioning these or all fans 23 in the central region 70, the main acoustic emissions are also generated in this central region 70. The increased distance between the openings of both the air inlet 26 and the air outlet 27 and the surrounding area 25 results in a higher degree of acoustic attenuation between the fans 23 as sound generators and the openings emitting sound to the surrounding area 25, thereby reducing the actual acoustic load emitted to the surrounding area 25.

According to FIGS. 1 and 2, the respective air duct 24 can be formed in a duct body 28 that represents a separate component with respect to the cooling plate 8 and also with respect to the frame structure 11. The duct body 28 can, for example, be made of a metal, preferably with high thermal conductivity. The respective duct body 28 can have a variety of ribs or webs, not shown here, which divide the associated air duct 24 into a corresponding number of subducts and which thereby provide a high surface area for heat transfer between the duct body 28 and the air guided in the air duct 24. The respective duct body 28 can be screwed, soldered, or welded to the cooling plate 8.

However, an embodiment in which no separate duct body 28 is used is preferred. Rather, 24 components that are preferably already available are used to form the respective air duct. As already mentioned, the housing 9 has a cooling plate 8 on its underside and a cover plate 10 on its upper side. Furthermore, the power electronic unit 3 in the housing 9 can be covered by an electronics housing 65. Likewise, coil 2 in housing 9 can be covered by a coil housing 66. The respective air duct 24 can now be delimited at the bottom by the cooling plate 8 or by a duct base plate 67 that is separate from the cooling plate 8, at the top by the cover plate 10 and laterally by a lateral wall 68 of the electronic housing 65 facing the coil housing 66 and through a lateral wall 69 of the coil housing 66 facing the electronics housing 65.

As can be seen from FIGS. 1 and 2, components 7 and units 4, 5, 6 of the power electronic unit 3 are arranged in an electronics region 29 on the upper side of the cooling plate 8. Coil 2, on the other hand, is arranged in a coil region 30 on the upper side of the cooling plate 8. The respective air duct 24 and the respective fan 23 are arranged in a heat exchanger region 31 on the upper side of the cooling plate 8. The heat exchanger region 31 is arranged in the longitudinal direction X between the electronics region 29 and the coil region 30. The electronics region 29, coil region 30, and heat exchanger region 31 are indicated in FIGS. 1 through 5 by curly brackets.

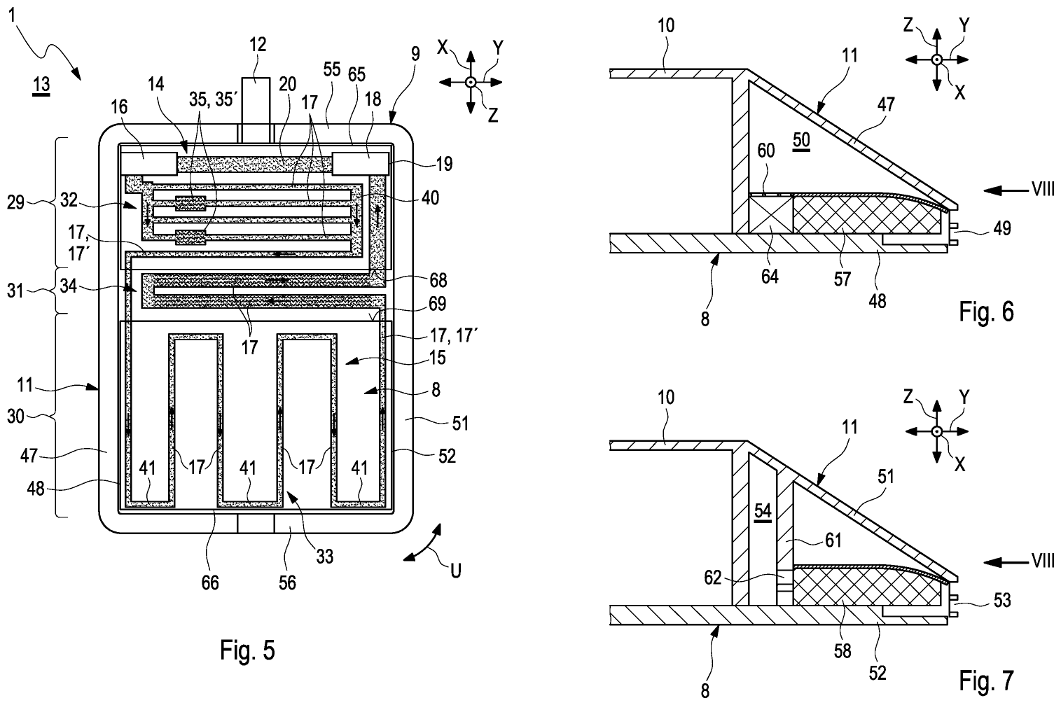

According to FIGS. 3 through 5, the cooling duct system 15 can have an electronic subsystem 32 running in the electronics region 29, which contains at least one cooling duct 17. Furthermore, the cooling duct system 15 can have a coil subsystem 33 running in the coil region 30, which contains at least one cooling duct 17. Finally, the cooling duct system 15 can have a heat exchanger subsystem 34 running in the heat exchanger region 31, which also contains at least one cooling duct 17. A heat exchanger structure 35 can be arranged in at least one cooling duct 17. In the examples of FIGS. 3 through 5, there is a heat exchanger structure 35 arranged in each cooling duct 17 of the heat exchanger subsystem 34. Furthermore, in the example of FIGS. 3 and 5, two flat duct sections 35′ and, in the example of FIG. 4, three flat duct sections 35′ are indicated in the electronic subsystem 32, in each of which a heat exchanger structure 35 is arranged. The flat 35′ duct sections are designed where the components 7 are located, which generate a particularly large amount of heat. The respective heat exchanger structure 35 can be formed by fins, studs, lamellae, turbulators or the like.

In heat exchanger subsystem 34, the cooling ducts 17 in the region of the respective air duct 24 may be open at the upper side of the cooling plate 8 and covered or closed at the top by the respective duct body 28 or the respective duct base plate 67. As a result, the coolant can come into direct contact with the respective duct body 28 or the respective duct base plate 67 when the induction charging device 1 is in operation.

In the examples of FIGS. 3 and 4, the heat exchanger subsystem has 34 cooling ducts 17′ that are arranged downstream of the cooling ducts 17 of the electronics subsystem 32. Furthermore, the heat exchanger subsystem has 34 additional 17″ cooling ducts that are connected in series with the 17 cooling ducts of the coil subsystem 33. Each of these cooling ducts 17″ of the heat transfer subsystem 34 is arranged between two cooling ducts 17 of the coil subsystem 33.

In the examples of FIGS. 3 and 4, a cooling duct 17 of the cooling duct system 15 forms a coil feed line 36 that guides the coolant from the conveyor 16 to the coil subsystem 33. Another cooling duct 17 of the cooling duct system 15 forms a separate electronic feed line 37 from the coil feed line 36, which feeds the coolant from the conveyor 16 to the electronic subsystem 32. Another cooling duct 17 of the cooling duct system 15 forms a common return line 38 that leads the coolant to the expansion tank 18. The electronic feed line 37 can also form a distribution duct 39 or merge into such a distribution duct 39. From this distribution duct 39, several cooling ducts 17 of the electronic subsystem 32 branch off and guide the coolant parallel to a collector duct 40. In the examples shown here, the cooling ducts 17′, which are connected downstream of the electronics subsystem 32, are connected to this collecting duct 40. The coolant thus reaches the cooling ducts 17′ of the heat transfer subsystem 34 from the collecting duct 40.

In the examples of FIGS. 3 and 4, the coil subsystem 33 comprises a plurality of cooling ducts 17 that run parallel to the longitudinal direction X of the induction charging device 1 and are spaced apart from one another in the transverse direction Y of the induction charging device 1. The coil subsystem 33 now has several connecting ducts 41 that run parallel to the transverse direction Y and connect neighboring cooling ducts 17 within the coil region 30. The aforementioned 17″ cooling ducts of the heat exchanger subsystem 34, which are connected in series with the 17 cooling ducts of the coil subsystem 33, also extend parallel to the transverse direction Y and connect two adjacent cooling ducts 17 of the coil subsystem 33 within the heat exchanger region 31.

FIG. 5 shows another example of a different connection or arrangement of the cooling ducts 17. In this case, the three subsystems mentioned, namely electronic subsystem 32, coil subsystem 33, and heat exchanger subsystem 34, are each connected in series by a connecting cooling duct 17′ so that the coolant is first conducted through the more thermally sensitive electronics region 29, then through the less thermally sensitive coil region 30, and finally through the heat exchanger region 31. This ensures that the sensitive components in the electronics region 29 are cooled by coolant at the lowest temperature, that the less sensitive components in the coil region 30 can still be sufficiently cooled by the coolant at a slightly higher temperature, and that the coolant is transferred at a maximum temperature to the thermal energy in the heat exchanger region 31, which is flowing through the air duct 24.

According to FIGS. 1 and 2, one of the air ducts 24 of the air duct system 22 forms an inlet duct 42 that conducts air from the respective air inlet 26 to the respective fan 23. Another air duct 24 of the air duct system 22, on the other hand, forms an outlet duct 43 that conducts air from the respective fan 23 to the respective air outlet 27. In the examples shown, at least two fans 23 are provided, which form two fan stages, namely a first fan stage 44 and a second fan stage 45, which are arranged one behind the other or in series in the direction of air flow. In the examples shown here, the first fan stage 44 has exactly one fan 23, while the second fan stage 45 has exactly two fans 23 that work in parallel. The inlet port 42 now guides air from the air inlet 26 to the first fan stage 44. Another air duct 24 of the air duct system 22 forms a connecting duct 46 that conducts air from the first fan stage 44 to the second fan stage 45. The exhaust duct 43 guides air from the second fan stage 45 to the air outlet 27.

The frame structure 11 connects to the edge of the cooling plate 8 and runs in a circumferential direction U around the induction charging device 1 or around its housing 9. The circumferential direction U is indicated by a double arrow in FIGS. 1 through 5, 8 and 9 and runs around the vertical direction Z. The frame structure 11 now has an inlet region 47 that extends at a first transverse end 48 of the cooling plate 8 in the electronics region 29, in the heat exchanger region 31, and in the coil region 30. The inlet region 47 has several air inlet openings 49, as can be seen in FIG. 6, and contains an air collector duct 50 that connects the air inlet openings 49 to the air inlet 26. Furthermore, the frame structure 11 has an outlet region 51, which extends in the transverse direction Y from the first transverse end 48, facing away from the second transverse end 52 of the cooling plate 8, in the electronics region 29, in the heat exchanger region 31, and in the coil region 30. The outlet region 51 has several air outlet openings 53, as shown in FIG. 7, and contains an air distribution duct 54 that connects the air outlet 27 to the air outlet openings 53.

In the embodiments shown in FIGS. 1 and 3 through 5, the inlet region 47 also extends over part of a first longitudinal end 55 of the cooling plate 8 and over part of a second longitudinal end 56 of the cooling plate 8, which is turned away from the first longitudinal end 55 in the longitudinal direction X. The outlet region 51 also extends over part of the first longitudinal end 55 and over part of the second longitudinal end 56. The inlet region 47 and the outlet region 51 are thus C-shaped in a line of sight running parallel to the vertical direction Z.

In the embodiment shown in FIG. 2, the inlet region 47 extends exclusively along the first transverse end 48, while the outlet region 51 extends exclusively along the second transverse end 52. In this case, the inlet region 47 and the outlet region 51 are designed in an I-shape when viewed in a direction I parallel to the vertical direction Z.

In the examples of FIGS. 3 and 5, all cooling ducts 17 of the cooling duct system 15 extend to an edge region at a distance, where the frame structure 11 is located. In contrast to this, the example in FIG. 4 envisages that at least one cooling duct 17, here the coil feed line 36, and a connecting duct 41, runs in an edge region of the cooling plate 8 that is assigned to the inlet region 47 of the frame structure 11. Furthermore, in this example, it is envisaged that at least one further cooling duct 17, here the common return line 38 and a connecting duct 41, runs in another edge region of the cooling plate 8, which is assigned to the outlet region 51 of the frame structure 11.

According to FIG. 6, at least one heat exchanger structure 57 can be arranged in the inlet region 47, which is connected to the cooling plate 8 in a heat-transferring manner. For example, the respective heat exchanger structure 57 can be glued or soldered to the cooling plate 8 or to its upper side. The respective heat exchanger structure 57 conducts air from the respective air inlet opening 49 to the air collector duct 50. In addition or as an alternative, at least one heat exchanger structure 58 can be arranged in the outlet region 51, as shown in FIG. 7, which is connected to the cooling plate 8 in a heat-transferring manner. The respective heat exchanger structure 58 conducts air from the air distribution duct 54 to the respective air outlet opening 53. The respective heat exchanger structure 57, 58 can be formed by lamellae 59 or ribs 59 or by another heat-transferring structure, as shown in FIG. 9.

In the embodiment shown in FIG. 6, the inlet ports 49 are connected to the plenum 50 via connecting ports 60. In the embodiment shown in FIG. 7, a partition 61 is formed in the outlet region 51, which delimits the air distributor duct 54. This partition wall 61 increases the stability of the frame structure 11 and the housing 9. The connection openings 62 create the connection between the air distribution duct 54 and the outlet openings 53. It is clear that the outlet region 51 can also be designed identically to the inlet region 47 shown in FIG. 6. It is also conceivable that the inlet region 47 can be designed identically to the outlet region 51 shown in FIG. 7.

The inlet openings 49 and the outlet openings 53 can basically be designed as desired. The embodiment shown in FIG. 8 is of particular advantage, in which the inlet opening 49 and the outlet openings 53 are arranged next to one another in the peripheral direction U and are separated from one another by arcuate supporting elements 63. These supporting elements 63 increase the stability of the housing 9 and the frame structure 11.

Optionally, at least one air filter 64 can be arranged in the inlet region 47, as shown in FIG. 6, through which the sucked-in air flows. In the example of FIG. 6, the air filter 64 is arranged so that the air flows through it when it is deflected from the cooling fins 47 to the connecting openings 60, i.e., before it enters the air collector duct 50.

1. A stationary induction charging device, comprising:
a coil for providing an electromagnetic alternating field;
a power electronics unit configured to supply energy to the coil and to control the coil;
a cooling plate connected to a plurality of components of the power electronics unit and to the coil in a heat-transferring manner;
a cooling device including:
a cooling duct system including a plurality of cooling ducts extending in the cooling plate and through which a coolant is flowable; and
a delivery device configured to drive the coolant in the cooling duct system; and
a ventilation device including:
an air duct system including at least one air duct connected to the cooling plate in a heat-transferring manner and through which air is flowable;
at least one fan configured to drive the air in the air duct system;
at least one air inlet communicating with a surrounding area of the induction charging device; and
at least one air outlet communicating with the surrounding area.

2. The induction charging device according to claim 1, further comprising:
a housing having an underside and an upper side, the cooling plate arranged on the underside of the housing and a cover plate arranged on the upper side of the housing;
an electronics housing, the power electronics unit disposed in the housing and covered by the electronics housing; and
a coil housing, the coil disposed in the housing and covered by the coil housing;
wherein the at least one air duct is delimited at a bottom via at least one of the cooling plate and a duct base plate that is separate from the cooling plate, at a top through via the cover plate, and a at a plurality of sides via the coil housing, a lateral wall of the electronics housing facing the coil housing, and a lateral wall of the coil housing facing the electronics housing.

3. The induction charging device according to claim 1, wherein the at least one air duct is formed in a duct body that is a separate component from the cooling plate.

4. The induction charging device according to claim 1, wherein the at least one air duct includes a duct base plate that defines a lower boundary of the at least one air duct is a separate component from the cooling plate, and is connected to the cooling plate in a heat-transferring manner.

5. The induction charging device according to claim 1, wherein the at least one fan is arranged in the at least one air duct at a distance from the at least one air inlet and at a distance from the at least one air outlet.

6. The induction charging device according to claim 1, wherein:
the plurality of components of the power electronics unit are arranged in an electronics region of the cooling plate;
the coil is arranged in a coil region of the cooling plate; and
the at least one air duct and the at least one fan are arranged in a heat exchanger region of the cooling plate, which is arranged in a longitudinal direction of the induction charging device between the electronics region and the coil region.

7. The induction charging device according to claim 6, wherein the cooling duct system further includes:
an electronics subsystem extending in the electronics region and including at least one cooling duct, of the plurality of cooling ducts;
a coil subsystem extending in the coil region and including at least one cooling duct, of the plurality of cooling ducts; and
a heat exchanger subsystem extending in the heat exchanger region and at least one cooling duct of the plurality of cooling ducts.

8. The induction charging device according to claim 7, wherein the electronics subsystem, the coil subsystem, and the heat transfer subsystem are arranged in series in the cooling duct system such that the coolant, when the cooling device is in operation, first flows through the electronics subsystem, then through the coil subsystem, and finally through the heat transfer subsystem.

9. The induction charging device according to claim 7, further comprising a plurality of heat exchanger structures arranged in the at least one cooling duct of at least one of the electronics subsystem, the coil subsystem, and the heat exchanger subsystem.

10. The induction charging device according to claim 7, wherein the at least one cooling duct of the heat exchanger subsystem is open in a region of the at least one air duct on an upper side of the cooling plate such that the coolant comes into direct contact with the at least one air duct when the induction charging device is in operation.

11. The induction charging device according to claim 7, wherein the at least one cooling duct of the heat exchanger subsystem is connected in series downstream of at least one of the electronics subsystem and the coil subsystem.

12. The induction charging deviceaccording to claim 7, wherein:
the at least one cooling duct of at least one of the coil subsystem and the electronics subsystem includes two cooling ducts; and
the at least one cooling duct of the heat exchanger subsystem is arranged between and connected in series with the two cooling ducts of one of the coil subsystem and the electronics subsystem.

13. The induction charging device according to claim 7, wherein:
a first cooling duct of the plurality of cooling ducts is a coil feed line that guides the coolant from the delivery device to the coil subsystem;
a second cooling duct of the plurality of cooling ducts is an electronics feed line that is separate from the coil feed line and that feeds the coolant from the delivery device to the electronics subsystem; and
a third cooling duct of the plurality of cooling ducts is a common return line.

14. The induction charging device according to claim 13, wherein:
the electronics feed line forms a distributor of the electronics subsystem; and
the at least one cooling duct of the electronics subsystem includes a plurality of cooling ducts that extend, in parallel, from the distributor to a collector of the electronics subsystem.

15. The induction charging device according to claim 14, wherein the at least one cooling duct of the heat exchanger subsystemis connected in series downstream of the collector and extends to the common return line.

16. The induction charging device according to claim 7, wherein:
the at least one cooling duct of the coil subsystemincludes a plurality of cooling ducts that extend parallel to the longitudinal direction and that are disposed spaced apart from one another in a transverse direction of the induction charging device;
the coil subsystem further includes a plurality of connecting ducts extending parallel to the transverse direction and connecting neighboring cooling ducts to one another in the coil region; and
the at least one cooling duct of the heat exchanger subsystem extends parallel to the transverse direction and connects neighboring cooling ducts of the plurality of cooling ducts of the coil subsystem to one another in the heat exchanger region.

17. The induction charging device according to claim 1, wherein:
the at least one air duct includes a plurality of air ducts;
a first air duct of the plurality of air ducts is an inlet duct that conducts air from the at least one air inlet to the at least one fan; and
a second air duct of the plurality of air ducts is an outlet duct that conducts air from the at least one fan to the at least one air outlet.

18. The induction charging device according to claim 17, wherein:
the at least one fan includes at least two fans that form a first fan stage and a second fan stage;
the inlet duct conducts air from the at least one air inlet to the first fan stage;
a third air duct of of the plurality of air ducts is a connecting duct that conducts air from the first fan stage to the second fan stage; and
the outlet duct extends from the second fan stage to the at least one air outlet.

19. The induction charging device according to claim 6, further comprising a frame structure connected to an edge of the cooling plate, wherein the frame structure includes:
an inlet region extending at a first transverse end of the cooling plate in the electronics region and in the coil region the inlet region including a plurality of air inlet openings open to the surrounding area and an air collecting duct connecting the plurality of air inlet openings to the at least one air inlet; and
an outlet region extending at a second transverse end of the cooling plate facing away from the first transverse end in a transverse direction, the outlet region including a plurality of air outlet openings open to the surrounding area and an air distribution duct connecting the at least one air outlet to the plurality of air outlet openings.

20. The induction charging device according to claim 19, wherein the inlet region further extends over at least a portion of a first longitudinal end of the cooling plate in the electronics region.

21. The induction charging device according to claim 20, wherein the inlet region further extends over at least a portion of a second longitudinal end of the cooling plate in the coil region.

22. The induction charging device according to claim 19, wherein the outlet region further extends over at least a portion of a first longitudinal end of the cooling plate in the electronics region.

23. The induction charging device according to claim 22, wherein the outlet regionextends over a portion of a second longitudinal end of the cooling plate in the coil region.

24. The induction charging device according to claim 19, wherein at least one of the plurality of cooling ducts extends in an edge region of the cooling plate assigned to the inlet region.

25. The induction charging device according to claim 19, wherein at least one of the plurality of cooling ducts extends in an edge region of the cooling plate assigned to the outlet region.

26. The induction charging device according to claim 1, wherein:
the cooling device is a cooling circuit;
the conveying device is a pump; and
the coolant is a cooling liquid.

27. The induction charging device according to claim 1, wherein:
the cooling device is a refrigeration circuit;
the conveying device is a compressor;
the coolant is a refrigerant; and
the refrigeration circuit includes an expansion valve.

28. An inductive vehicle charging system for charging a battery of a battery-electric vehicle, comprising:
the stationary induction charging device according to claim 1; and
a mobile induction charging device that is arranged on the vehicle.
